(19) United States
(12) Patent Application Publication
(10) Pub. No.: US 2014/0037884 A1
(43) Pub. Date: Feb. 6, 2014

(54) AUTOMATED SYSTEM FOR PERSONALIZING CONTAINER DECORATIONS WITH ARTISTIC ARRANGEMENTS

(71) Applicant: Cinnamon Bay Partners, LLC, Hudson, MA (US)

(72) Inventors: Craig A. Wambolt, SOUTHBOROUGH, MA (US); Michael Devlin, FRAMINGHAM, MA (US); David M. Sears, NORTHBOROUGH, MA (US); Matthew A. Chepeleff, COVENTRY, CT (US)

(73) Assignee: Cinnamon Bay Partners, LLC, Hudson, MA (US)

(21) Appl. No.: 13/903,969

(22) Filed: May 28, 2013

Related U.S. Application Data
(63) Continuation-in-part of application No. PCT/US12/69324, filed on Dec. 12, 2012.
(60) Provisional application No. 61/569,777, filed on Dec. 12, 2011.

(51) Int. Cl. G06F 17/50

(52) U.S. Cl. CPC G06F 17/50
USPC 428/43; 703/1

(57) ABSTRACT

An automated system for personalizing containers with artistic arrangements, such as flowers, provides a customer with the ability to personalize a custom decoration for the container. Specifically, the customer can select a design and include personal images and greetings. In particular, the personalized decoration can be built by layering user selected images and text on a virtual canvas. An automated system can assist the customer by coordinating colors between the personalized decoration and the arrangement to yield a visually appealing package. The resulting personalized content can be printed on a water-resistant film for insertion within a clear vase.

### RELATED APPLICATIONS

This application is a Continuation-In-Part of International Application No. PCT/US12/69324 filed on Dec. 12, 2012, which claims the benefit of U.S. Provisional Application No. 61/569,777 filed on Dec. 12, 2011. The entire teachings of the above applications are incorporated herein by reference.

### BACKGROUND

Arrangements of flowers, plants, cookies, fruit, and other goods are often given for holidays and other occasions. Artisans will typically select and arrange the goods to convey a desired atmosphere or mood. An important aspect of achieving an artistic arrangement is coordinating colors.

Containers such as vases, pots, and baskets are usually used to present the artistic arrangements. Vase style and art play an important role in image and design, as they help create ambiance and influence the overall interior design strategy of a room. Vases as decorative items, and as shipping containers, have been important commercial objects since pre-historic eras in cultures as disparate as China, Egypt and Greece.

In the modern world, customers can order artistic arrangements for delivery to recipients that can be located in far from the customers. In particular, a customer can select an arrangement from a selection of available arrangements. While internet ordering systems have provided customers with the ability to visualize a fixed selection of artistic arrangements before ordering, the selection of artistic containers remains limited.

For various reasons, many potential customers may not personally have the ability to create artistic arrangements. In the floral industry, a well-stocked flower shop may have staff that can assist a customer in picking a bouquet and a suitable vase for an occasion. Typically, however, the customer would be offered only few vase options. While the vases may be available in a few styles, they are typically made of clear glass. Even if ceramic vases are offered, they are limited to a few colors or designs. Personalization is generally limited to adding a card with a personal message or bows and ribbons.

### SUMMARY

Particular embodiments of the invention provide a customer with the ability to personalize a custom decoration for a container. Specifically, the customer can select a design and include personal images and greetings. In a particular embodiment, the personalized decoration can be built by layering user selected images and text on a virtual canvas. An automated system can assist the customer by coordinating colors between the personalized decoration and the arrangement to yield a visually appealing package. The resulting personalized content can be printed on a water-resistant film for insertion within a clear vase. The automated system can be operated over the Internet or from a local kiosk.

One particular embodiment of the invention is a computerized method of customizing an artistic arrangement. The method can include designing a customized container decoration having a personal content item and selecting an artistic arrangement from images representing a plurality of artistic arrangements.

More particularly, digital editing techniques can be used to customize the artistic arrangement. For example, the personal content item can be solicited from a user by accepting a digital image. In addition, designing the customized container decoration can include editing a two-dimensional representation of a three-dimensional container surface, such as a vase insert. That editing can include digitally adding the personal content item to a digital template. Furthermore, the personal content item can be arranged relative to the digital template.

The artistic arrangement can be selected by calculating a numerical color palette of the customized container, and programmatically comparing the numerical color palette of the customized container with a numerical color palette of at least one artistic arrangement. From the comparison, an ordered list of artistic arrangements can be generated that have numerical color palettes that best match the numerical color palette of the customized container decoration. In particular, the numerical color palette of the customized container can be calculated to include the personal content item.

The customized container decoration can then be combined with a physical version of the artistic arrangement at a fulfillment center.

Another particular embodiment of the invention can include an automated method for customizing a vase with a floral arrangement. That method can include designing a customized vase decoration having a personal image and selecting a floral arrangement from images representing a plurality of floral arrangements. The designing and selecting steps can occur in either order.

More particularly, digital editing techniques can be used in the automated method. For example, the personal image can be selected by the user as a digital image. In addition, the customized vase decoration can be designed by editing a two-dimensional representation of a three-dimensional vase surface. That editing can includes digitally adding the personal image to a digital template. The personal image can be arranged relative to the digital template. More specifically, designing a customized vase decoration can include designing a vase insert.

The artistic arrangement can be selected by calculating a numerical color palette of the customized vase decoration and programmatically comparing the numerical color palette of the customized vase decoration with a numerical color palette of at least one artistic arrangement. From the comparison, an ordered list of artistic arrangements can be generated that have numerical color palettes that best match the numerical color palette of the customized vase decoration. The numerical color palette of the customized vase decoration can be calculated to include the personal image.

The customized vase decoration can be combined with a physical version of the artistic arrangement at a fulfillment center.

The invention can be embodied as hardware, software, firmware, or in a computer program product that includes a computer-usable medium. As such, other particular embodiments of the invention can also include apparatuses, devices, products, systems, and articles of manufacture employing computer code segments embodied on computer-readable mediums. Further embodiments include product made by any of the method embodiments.

One particular embodiment of the invention can include a computerized system for customizing an artistic arrangement. That system can include a design interface module for designing a customized container having personal content item and a selection interface module for selecting an artistic arrangement from images representing a plurality of artistic arrangements.

Another particular embodiment of the invention can include an automated system for customizing a vase with a floral arrangement. That system can include a design interface module for designing a customized vase decoration having a personal image and a selection interface module for selecting a floral arrangement from images representing a plurality of floral arrangements.

A particular product can include a product for customizing a floral vase. Such a product can include a sheet of water-resistant material having a printable surface, the sheet being scored to define an area that complements an inner surface of a vase, and an image printed on the printable surface within the scored area.

More particularly, the sheet of water-resistant material can include a peripheral area around the scored area. The peripheral area can includes printed information, such as color-check information. In addition, the scored area can include an overlap area.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a system diagram of a particular automated ordering system for personalizing artistic arrangements in accordance with the invention.

FIG. 2 is a schematic diagram of exemplary database tables for the system of FIG. 1.

FIGS. 3A-3D is a flowchart of an exemplary personalized ordering system of FIG. 1 in accordance with a particular embodiment of the invention.

FIG. 4 is a screenshot of a particular user interface for uploading image files to the image library.

FIG. 5 is a screenshot of a particular user interface for applying an image.

FIG. 6 is a screenshot of a particular user interface for selecting a design template.

FIG. 7 is a screenshot of a particular user interface for an image positioning tool.

FIG. 8 is a screenshot of a particular user interface for a text editing tool.

FIG. 9 is a screenshot of a particular user interface for displaying a vase with a completed decorative canvas.

FIG. 10 is a screenshot of a particular user interface for displaying flower arrangements.

FIG. 11 is a screenshot of a particular user interface for displaying the built product for approval.

FIG. 12 is an exemplary production decorative image as stored in cloud storage 40.

FIG. 13 is an engineering drawing for perforating a sheet of printable medium for use in separating a region having the desired decorative image from the waste peripheral area.

FIG. 14 is an exemplary production order form as stored in cloud storage 40.

FIG. 15 is a flowchart for back-end processing.

FIGS. 16A-16D is a flowchart of an alternative embodiment for the personalizing process of FIG. 3.

### DETAILED DESCRIPTION

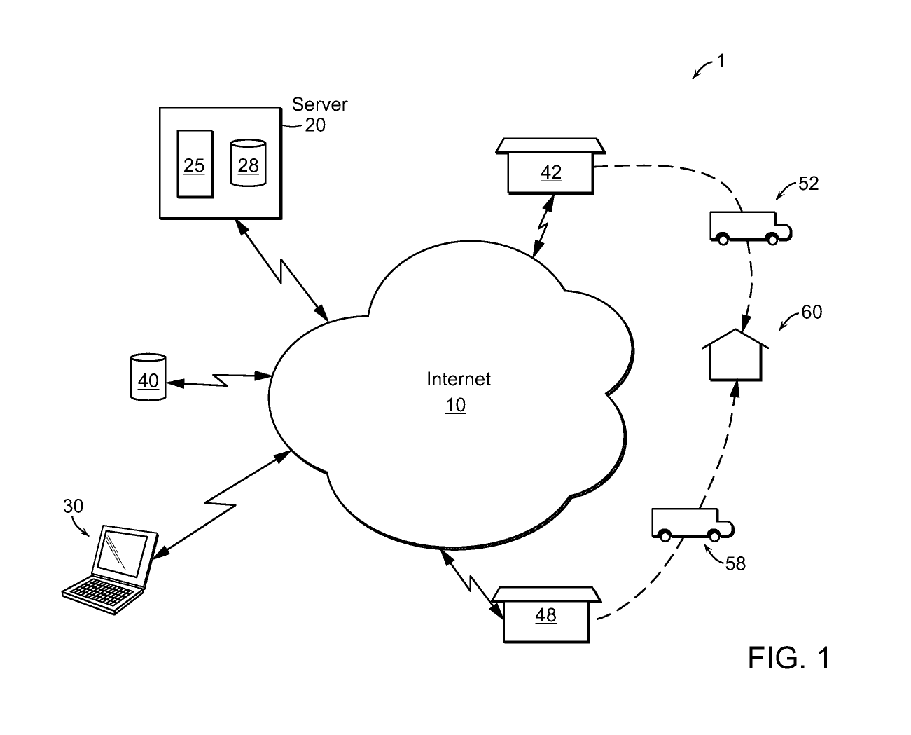

FIG. 1 is a system diagram of a particular automated ordering system for personalizing artistic arrangements in accordance with the invention. As shown, the ordering system 1 operates through a wide area network (WAN) such as the Internet 10. A provider ordering website 25 is maintained on a provider server 20, where it is accessible by customers through the Internet 10 using client browsing devices 30, such as personal computers, smartphones, electronic tablets, etc. As also shown, the ordering website server 20 includes a database 28 for storing data related to the ordering process. In a particular embodiment, the database includes information related to design templates and stock arrangements.

In a particular embodiment, the ordering website offers floral arrangements. For clarity and ease of understanding, the invention will generally be shown and described in terms of floral arrangements, but it should be understood that the principles of the invention can be applied to other deliverable or gift products having a container.

Using the client browsing device 30, a customer accesses the ordering website 25 and builds an order for a floral arrangement that includes a vase having a personalized decoration. The customer order includes a delivery address for an intended recipient 60. The details of the order are securely stored on an Internet-accessible storage system 40, such as provided by numerous commercial cloud storage providers.

The web server 20 assigns the order to a fulfillment center based on the delivery address. The fulfillment center can be a regional warehouse 42 or a local store 48, depending on the provider's business model. In a particular embodiment, the fulfillment centers are equipped with specialized printers to print the personalized vase decorations. Such printers can instead be located off-site with the printed decoration being delivered to the fulfillment center. After the personalized order is fulfilled, the floral arrangement with personalized vase is forwarded to the recipient 60 via either a third-party courier (Federal Express, United Parcel Service, etc.) 52 or a local courier 58.

One aspect of the invention relates to assisting customers in matching colors of the vase decoration to create an artistic arrangement. To aid in personalizing an order, existing design templates and arrangements are pre-processed to determine their dominant colors. That information is stored in a database table in the server database 28.

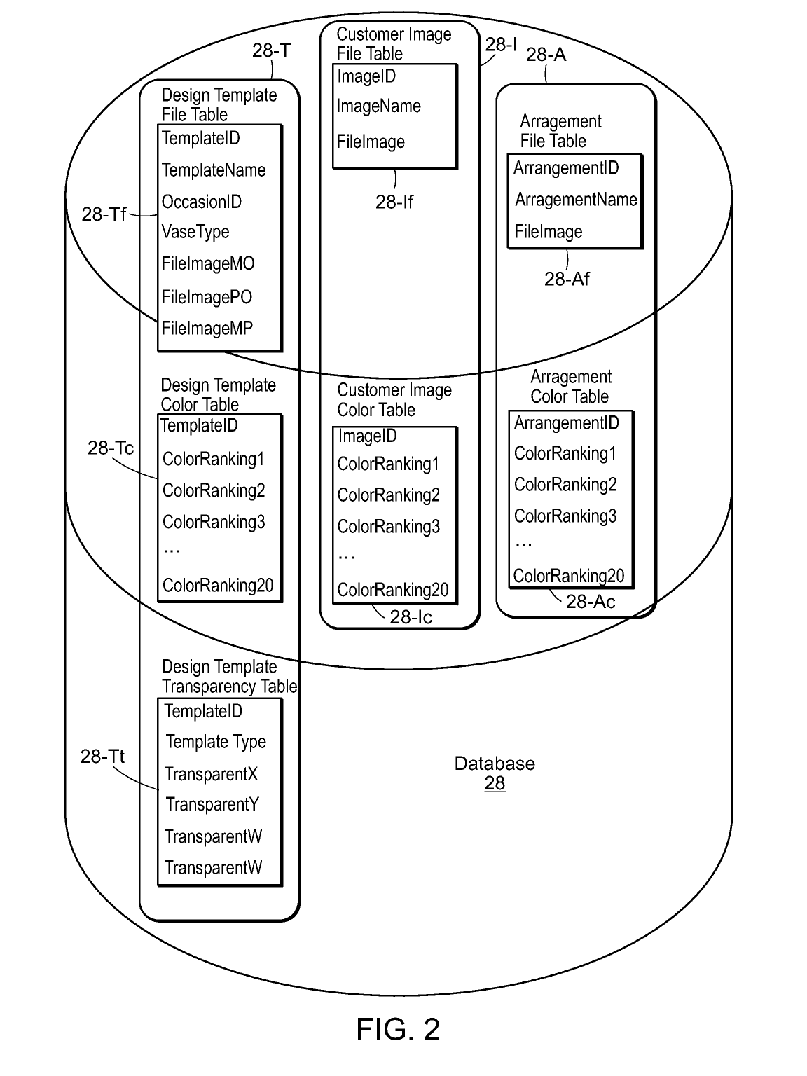

FIG. 2 is a schematic diagram of exemplary database tables for the system of FIG. 1. The database tables reflect the three primary components of a completed personalized product, namely design templates, personalized images (e.g. photographs, artwork), and arrangements. The design templates generally are defined by a design image, possible transparency areas for incorporating personalized images, and a message area for incorporating a text message. The addition of personalized images and text messages to the design image yields a personalized decoration.

As shown, the database 28 includes a Design Template Table Structure 28-T, a Customer Image Table Structure 28-I, and an Arrangement Table Structure 28-A. As shown, each structure includes a plurality of related tables. To that end, each table includes a column for a unique identifier, such as a SKU code for design templates and arrangements. Also, while the tables are shown as being within the server database 28, it should be understood that some or all data can be stored in cloud storage, depending on design considerations. Furthermore, fewer or more tables can be employed, and tables can be defined differently.

The design templates, arrangements, and customer images are each manifested as one or more images stored in respective image files. In the example, each structure includes a file table 28-Tf, 28-If, and 28-Af that stores information related to the stored image files. In addition to the location of the stored files, each file table can store a short name for display to the customer. It should be noted that a design template can have multiple variations, specifically one having a message only field, one having a photo only field, and one having both a photo and a message field. In addition, a design template can be associated with particular occasions or particular vases, which are reflected in respective fields.

As will also be discussed below, photographic images can be added to the design templates by the customer. To accommodate photographs, design templates that are compatible with a photo image have a transparency area that is layered over a photo image. A transparency table 28-Tt defines the starting coordinates and dimensions of a photo field that will receive the photographic image. While the transparency area can be of any shape, the photo field is a rectangular area over which the transparency area is layered. Because a photo-only design template may have a different transparency area than a photo-and-message design, a TemplateType field is used to keep them separate. It should be understood that a design template can have more than one transparency area for presenting multiple images, which can be reflected in the table.

While not shown, the Design Template Structure 28-T can also include a table to store information related to personalized messages, such as default location, font attributes, etc. The personalized message is layered over the design template image.52

The dominant colors representing each image are used to customize a decoration. To that end, each structure includes a color table 28-Tc, 28-Ic, 28-Ac for storing the dominant colors in the color space for images. The color tables store a fixed number (e.g. 20) of dominant colors in hexadecimal format, ranked in order of occurrence in the respective color space. That is, the most dominant color will be stored in the ColorRank1 column and the 20th dominant color will be stored in the ColorRank20 column. Those rankings will be used to compare with other images and to score matches.

It would be computationally difficult to match colors between two images that have a large number of pixels, each with a color from a large color space. For example, a typical image may have 5 million pixels, each with a color composed of 256 possible red values, 256 possible green values, and 256 possible blue values. Not only would it be time consuming to analyze every pixel, but the chances of finding meaningful exact color matches in such a large color space is small. In accordance with particular embodiments of the invention, the system reduces both the number of pixels to analyze and the size of the color space.

For the particular color-matching algorithms, all images are normalized to a common specification. First, the images are rescaled to be 100 superpixels wide. The aspect ratio of the original image is maintained so that the image height is not fixed. The process of rescaling converts many original pixels into a single superpixel, which has a color representative of the original pixels. The resulting image is thus a pixilated version of the original image.

Next, the superpixels in the pixilated image are sampled to determine a representative color. In a particular embodiment, the pixilated image is divided into blocks of 10 by 10 superpixels. The center point of each block is then used to represent the color of each block. Alternatively, the color values of all the superpixels in each block could be averaged or nearest-neighbor algorithms could be employed to determine a representative color. However, picking the central color from each block is faster than doing additional calculations. The result is data from a small subset of the original number of pixels.

While the number of data point has been reduced by sampling the blocks of superpixels, each data point still has a color from a large color space. To increase the chances of matches between very similar color shades, the size of the color space is reduced by a color rounding process. In a particular embodiment, each RGB component color is scaled to 60 possible values. That represents about 13% of the color information in a more typical 256×256×256 color space. It should be understood that the numerical value of 60 was found to be suitable for a particular embodiment, but that a smaller or larger color space could also be employed. Furthermore, other embodiments of the invention may find that a different color space would be more appropriate.

After color rounding, the system counts the number of times each color appears.

The most common color is assigned a color ranking of 1, etc. Those ranking are stored in the respective tables 28-Ac, 28-Tc, 28-Ic. For transient images (customer uploads), the system can instead store the ranking in memory. After counting, it is possible for multiple rounded colors to appear an equal number of times, so the tied colors are assigned a ranking based on any suitable method.

One tie-breaking method is to assign the ranking order of tied colors based on order of appearance in the image. That method, however, results in earlier scanned blocks being favored over later scanned blocks. In an algorithm that scans blocks linearly or in a raster fashion, the earlier blocks may be located along a peripheral edge of the image that may even be absent from the final decoration. Thus the colors representing peripheral blocks would have a higher ranking. In an algorithm that scans blocks outwardly from a central block, the colors representing the more central blocks are favored more than the colors representing the peripheral blocks. Alternatively, weightings can be applied based on block position to favor central block colors over peripheral block colors.

Another method is to assign ranking order of tied colors based on closeness to a pre-specified theme color, such as a color or colors associated with an occasion. For example, the color red could be pre-specified for Valentine's Day and tied colors are ranked based on closeness to red. Furthermore, one or more clash colors can be pre-specified such that colors closest to the clash colors would be ranked lower or even excluded from the rankings. It should be understood that the use of pre-specified colors is not limited to tie-breaking algorithms but can be employed to weigh rankings in general.

Color matchings are determined by a weighted scoring of the rankings. In a particular embodiment having 20 rankings, the top ranking is assigned a score of 20 and the lowest ranking is assigned a score of 1, as follows:

| | | |
|---|---|---|
| Rank 1 | => | Score 20 |
| Rank 2 | => | Score 19 |
| Rank 3 | => | Score 18 |
| . . . | | |
| Rank 20 | => | Score 1 |

If two images share a color, then the ranking scores for the color from both ranking lists are summed. A color-matching score is the total ranking scores for all matched colors. Consequently, the highest possible score between two images would be: 2*(20+19+18+ . . . +1)=420.

To illustrate, assume the following three matches are found between two images:

| Image A | | Image B |
|---|---|---|
| Ranking 1 | = | Ranking 10 |
| Ranking 15 | = | Ranking 12 |
| Ranking 16 | = | Ranking 1 |

The weighted scores would then be:

| Image A | | Image B | | Total |
|---|---|---|---|---|
| 20 | + | 11 | = | 31 |
| 6 | + | 9 | = | 15 |
| 5 | + | 20 | = | 25 |
| | | | | 71 |

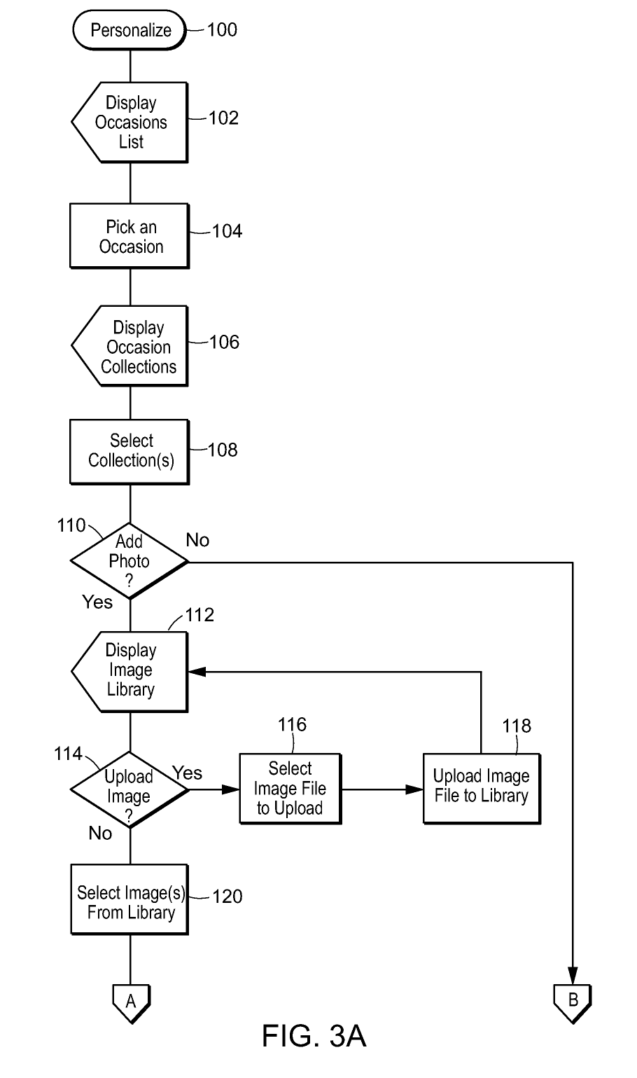

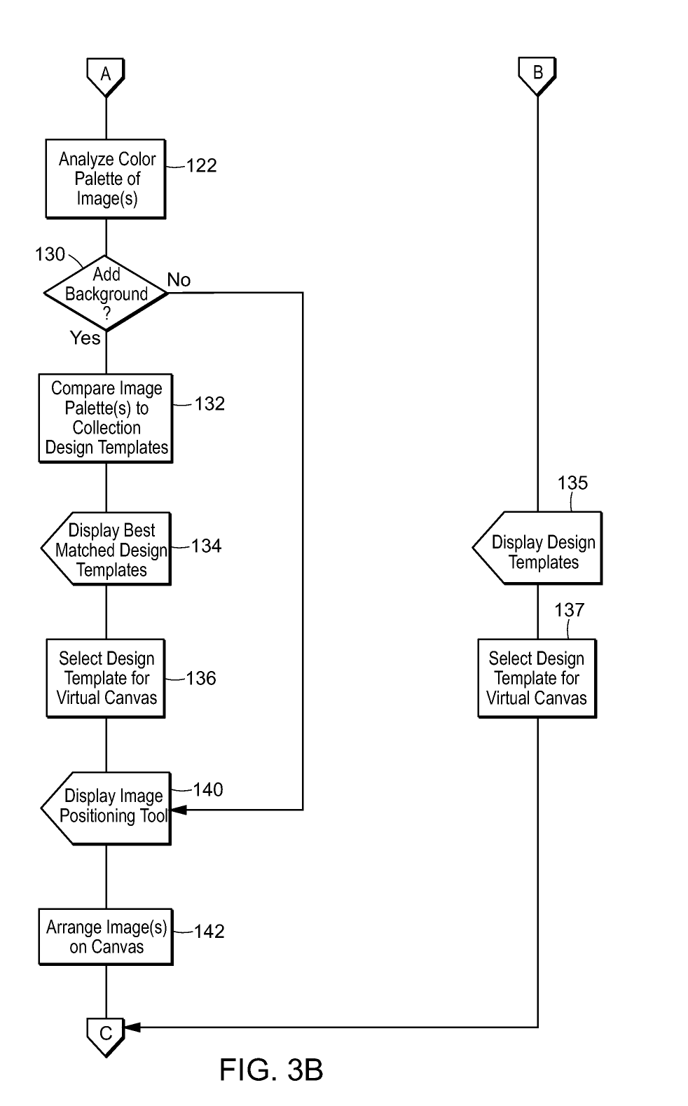

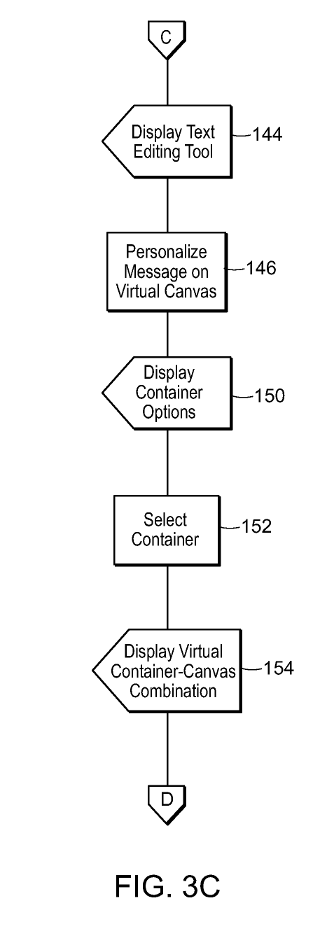

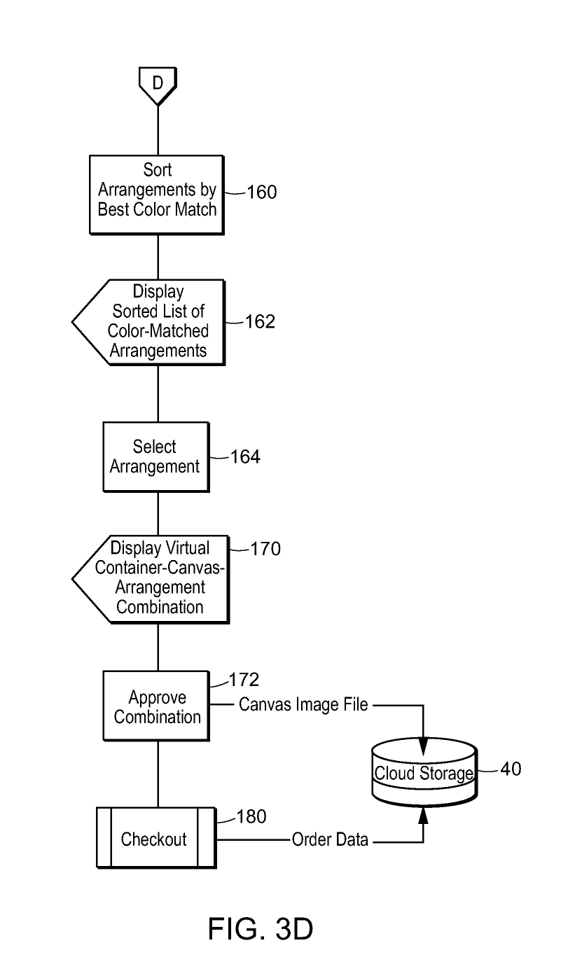

FIG. 3 (consisting of FIGS. 3A-3D) is a flowchart of an exemplary personalized ordering system of FIG. 1 in accordance with a particular embodiment of the invention. To make full use of the system, the customer is logged into an account or has enabled browser cookies to allow the ordering system to maintain context with the customer account.

As shown, the personalized ordering system 100 begins at step 102, where the system displays a list of occasions, such as holidays, seasons, events, celebrations, etc. It should be understood that the occasion list can vary depending on the date to limit the display of future holidays and seasons. At step 104, the customer selects an occasion from the list. This allows the system to narrow the choice of pre-existing design templates to appropriate options.

At step 106, the system displays a list of design collections that have design templates suitable for the currently-selected occasion based on the OccasionID field in the Design Template File Table 28-Tf. The collections can include proprietary designs, third-party commercial designs (Disney, Hallmark, etc.), private designs owned by the customer, and public user-community designs. The customer then selects one of more design collection at step 108, which will be later searched for recommended designs.

At step 110, the customer has the option of adding a photo or photos to the personalized design. If a photo is desired, processing continues to step 112; otherwise processing jumps to step 135.

At step 112 the system displays thumbnails of all image files currently stored in the customer's image library (according to the Customer Image File Table 28-If). The image library can include all image files previously uploaded for the customer's account. The customer can add or delete image files from the image library. If the customer decides to upload a new image at step 114, the customer then selects a new image file at step 116. The image file can be uploaded from the customer's local computer, from a social networking site, or from an internet address. At step 118, the uploaded image file is stored into the image library, which is updated. Processing then returns to step 112 to refresh the image library display. Once the customer is happy with the contents of the image library, processing continues to step 120 where the customer selects at least one image to use.

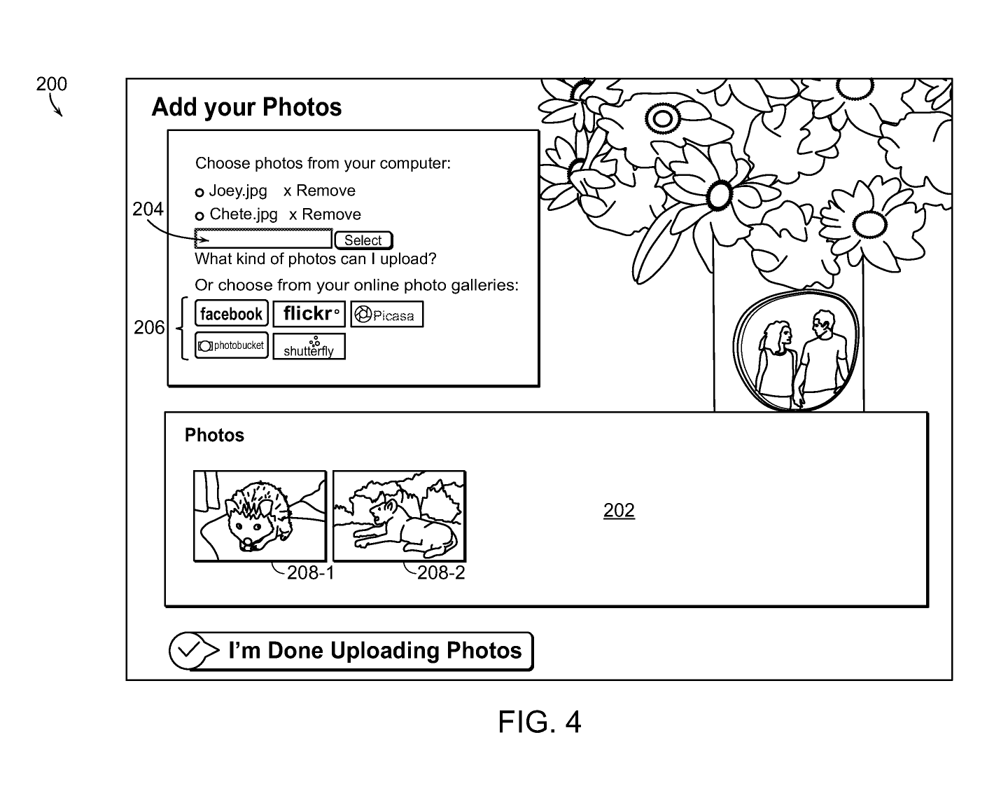

FIG. 4 is a screenshot of a particular user interface for uploading image files to the image library. As shown, the user interface 200 includes a virtual light box 202 for displaying thumbnails of images in the image library. While the light box 202 can be initially empty to indicate that the customer has no images in the library, the figure shows two images 208-1, 208-2 that have been uploaded. The customer can upload additional image files by browsing for a local file or directly entering a URL in an address box 204. The user interface also includes buttons 206 to connect to various social media networks. The user can also maintain the library by deleting image files.

Returning to FIG. 3, at step 122, the system analyzes the reduced color palette of the selected images to rank the dominant colors in the images as discussed above. In a particular embodiment, the system assumes that the center of the image is more relevant than the outer regions of the image. As such, the rankings can be weighted so that the blocks nearer the center of the image are ranked higher than outer blocks.

At step 130, the customer can elect to use the images alone as the design and jump to step 150 or to add the images to a design template and proceed to step 132. It should be understood that the selected image file can include a full vase decoration, in which case the customer would typically decline to use a design template.

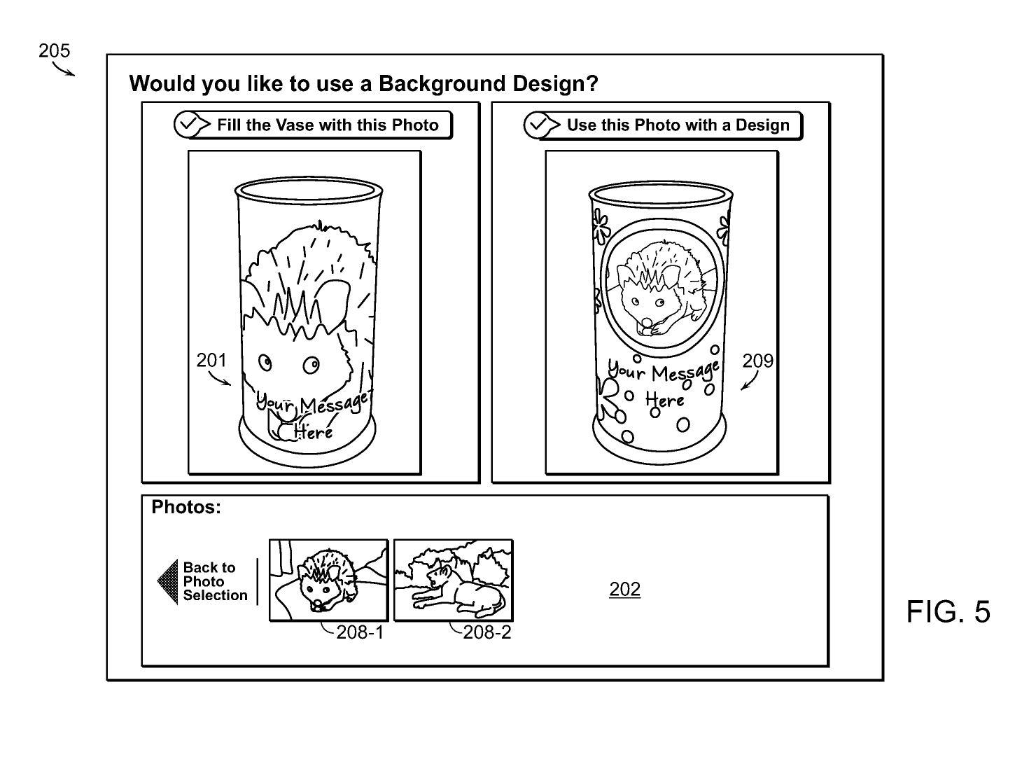

FIG. 5 is a screenshot of a particular user interface for applying an image. As shown, the virtual light box 202 with images 208-1, 208-2 is displayed to the customer. Also displayed is a rendering of a vase for both options: photograph only 201 and photograph with a default design template 209. When multiple images are available, the customer can select the sample image for the renderings. Likewise, when multiple vases may be available, the customer can select a sample vase type for rendering. The customer can then select how to proceed.

Returning to FIG. 3, at step 132, the system compares the reduced image palette of the selected photo image to the image palettes for the design templates in the selected collection to determine a match score as described above. At step 134, the system displays the best-matched design templates to the customer. In a particular embodiment, the design templates are displayed based on their color-matched rankings, best matched first. At step 136, the customer selects a design template to use on the virtual canvas.

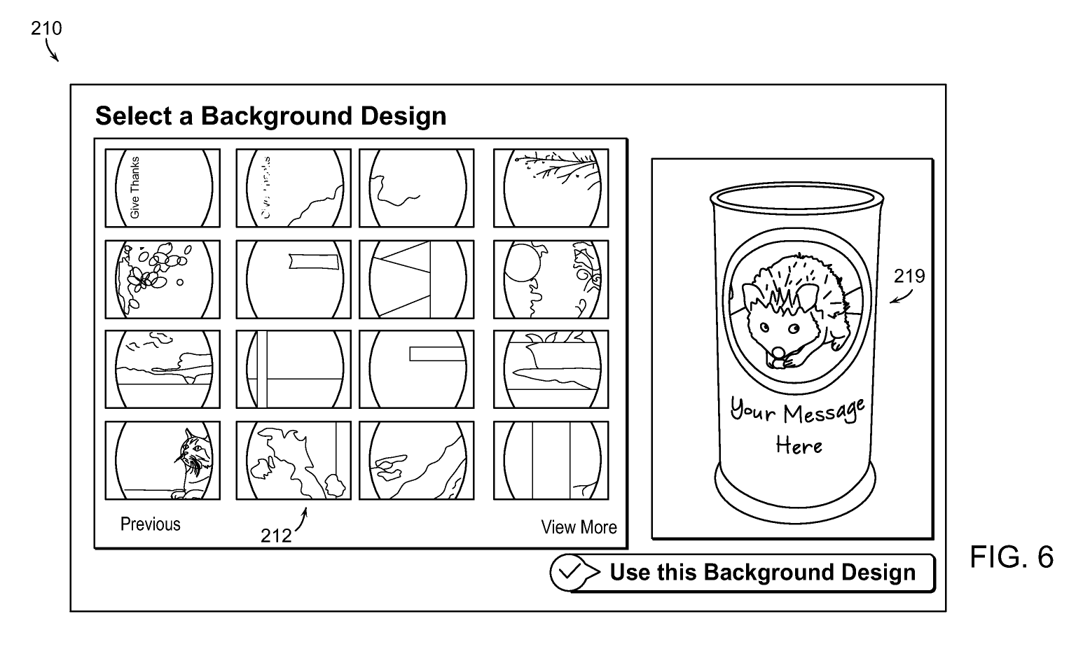

FIG. 6 is a screenshot of a particular user interface for selecting a design template. The user interface 210 includes a display of thumbnails for a plurality of design templates 212. The customer can select a thumbnail and a preview image 219 of the design template (including selected image) fitted to a vase is displayed to the customer.

Continuing to step 140 of FIG. 3, which also branches from step 130 when the customer decides to use an image alone, the system displays an image positioning tool.

At step 142, the image positioning tool allows the customer to manipulate the position and zoom level of the image(s) on the canvas. In other embodiments, the image positioning tool can digitally process the image appearance (brightness, contrast, etc.). Once the customer is satisfied with the image, processing continues to step 144.

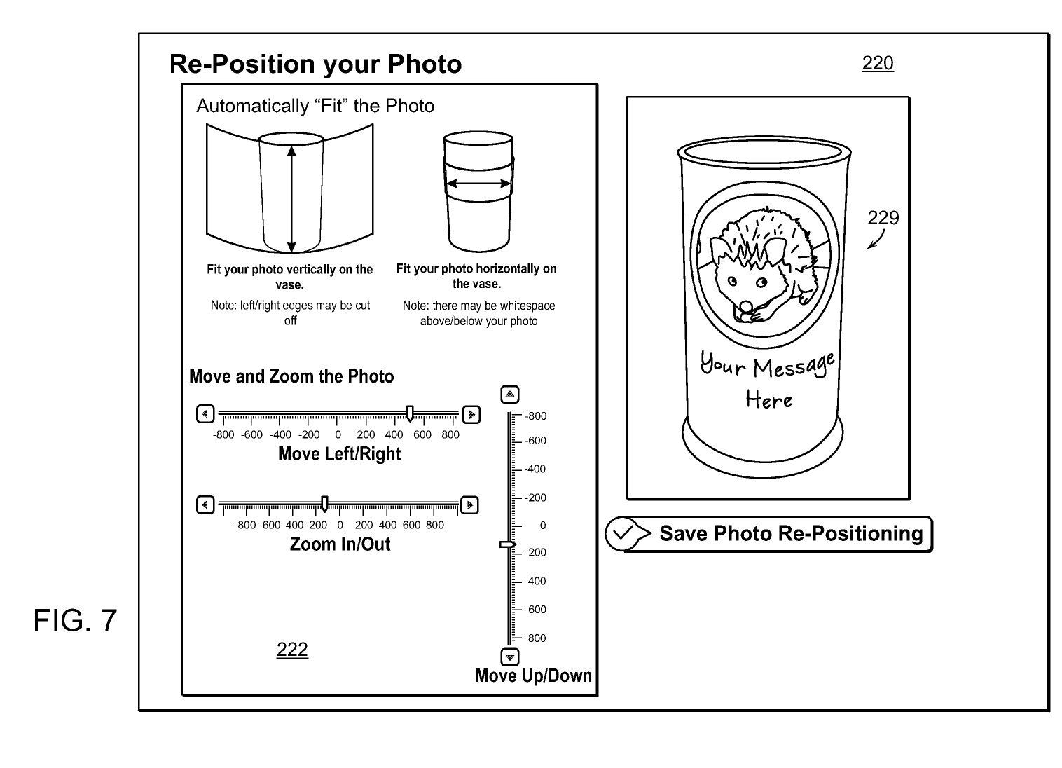

FIG. 7 is a screenshot of a particular user interface for an image positioning tool. As shown, the user selected photograph is resized to fit the defined photo image field for the design template and is layered behind the design template image. The user interface 220 includes image manipulation tools 222 and a preview image 229 that reflects changes to the image layout. While a particular user interface employing sliders is shown, other interfaces can be employed.

Returning to step 110 of FIG. 3, if the customer does not incorporate an image into the design then processing continues to step 135. At step 135, the system displays all design templates for the selected occasion to the customer. At step 137, the customer selects a design template to use on the virtual canvas. Processing then continues to step 144.

At step 144, the system presents the customer with a text editing tool. The text editing tool allows the customer to add a custom text message to the design. The default text color, font, and position are determined by a design theme associated in the database with the design template. At step 146, the customer enters the desired message and makes any desired changes to the color and font. In a more particular embodiment, the customer can customize the position of the desired message.

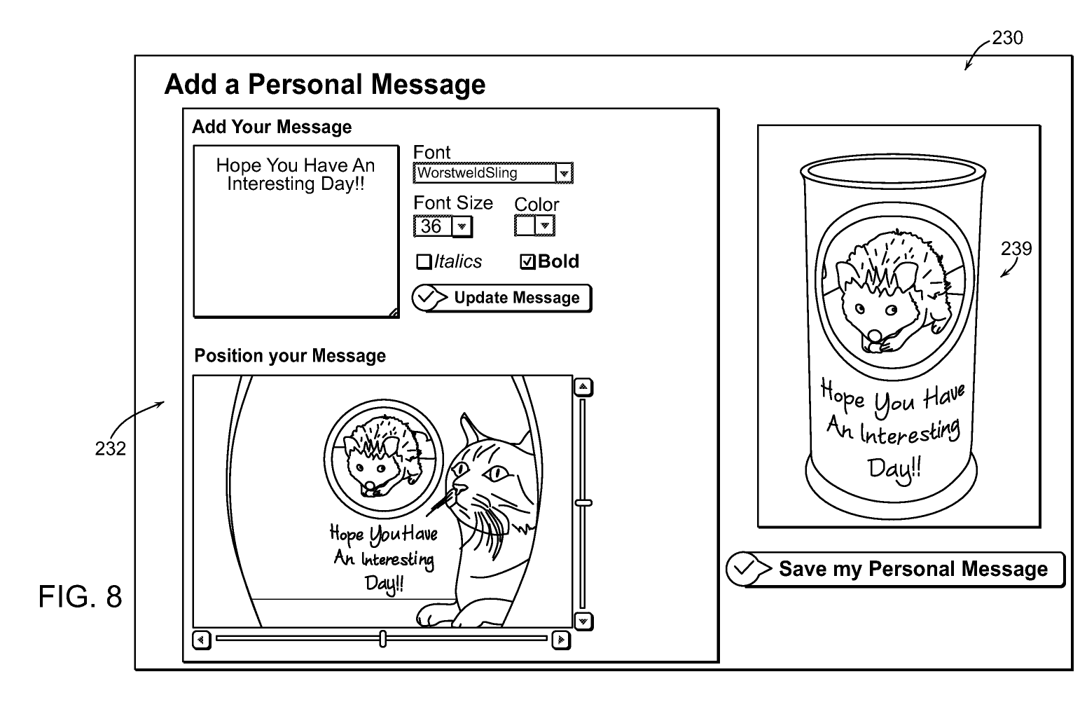

FIG. 8 is a screenshot of a particular user interface for a text editing tool. The user interface 230 includes text editing tools 232 and a preview image 239 that reflects changes to the text.

At step 150 of FIG. 3, the system displays container (e.g. vase, pot, or basket) options for the arrangement. The customer then selects a container to include in the order at step 152. At step 154, the system displays a 3D representation of the container and completed canvas design. As noted above, the selection of container style can be done earlier in the process, such as while selecting an image or a design template. More particularly, some design templates may be more suitable for some containers than others, the relationships between the design templates and container options are stored in the database. Now, the customer can select an arrangement to send to the recipient.

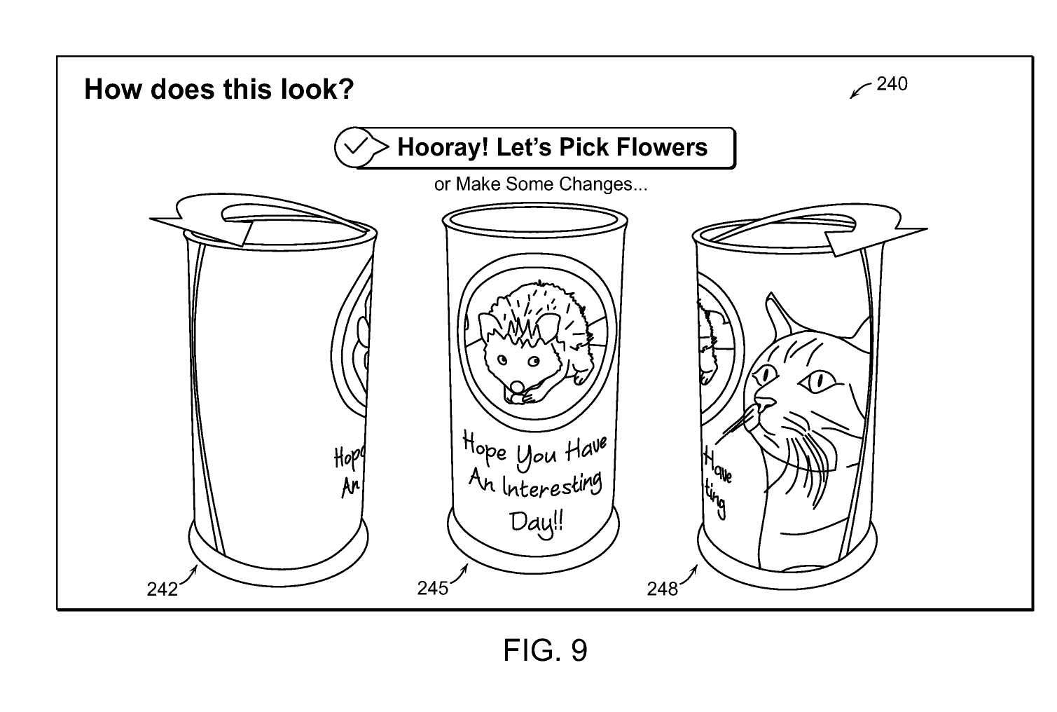

FIG. 9 is a screenshot of a particular user interface for displaying a vase with a completed decorative canvas. As shown, three views are given of the design: a 90° counter-clockwise rotated view 242, a front view 245, and a 90° clockwise rotated view 248. Other techniques can instead be used to display a three-dimensional rendering.

To assist the customer, the system employs the color matching algorithm to suggest specific arrangements to complete the order. At step 160 of FIG. 3, the system compares the color palette of the completed canvas with the color palettes of available arrangements, the dominant colors for which are pre-stored in the database. At step 162, displays a sorted list of the best matched arrangements. At step 164, the customer selects a desired arrangement for the order.

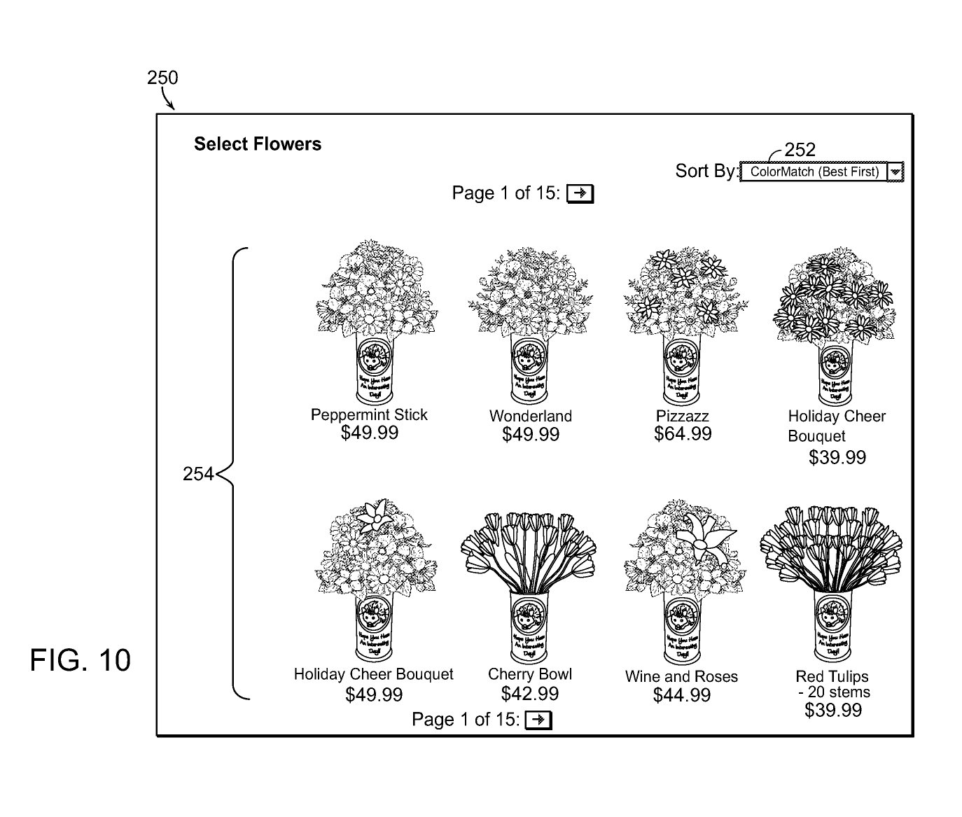

FIG. 10 is a screenshot of a particular user interface for displaying flower arrangements. As shown, the user interface 250 displays arrangements sorted by color matching ranking. The arrangements 254 are shown as images with the various flower arrangements as heads on the built vase-design combination.

Returning to FIG. 3, at step 170, the system displays the chosen combination of container, design canvas, and arrangement to the customer for final review. At step 172, the customer approves the combination for the order. Upon approval, the system stores an image file having the decorative canvas image in the cloud storage 40.

It should be understood that while the invention has been described with reference to stock arrangements, custom arrangements are also anticipated. In particular, the color matching algorithm can be employed to assist the customer in building a custom arrangement. For example, the customer can select individual flowers for a personalized bouquet or modify a pre-existing bouquet with the aid of the color matching algorithm.

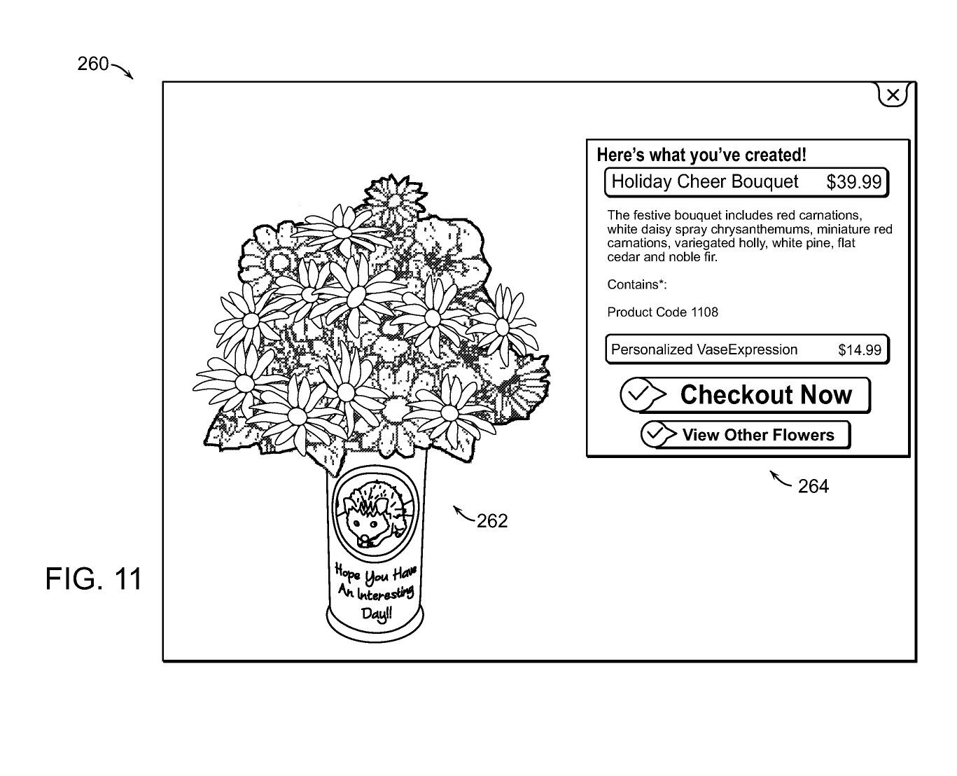

FIG. 11 is a screenshot of a particular user interface for displaying the built product for approval. As shown, the user interface 260 includes an image of the personalized product 262 and details of the order 264, including price, before checkout.

The customer completes the order through a checkout process at step 180 of FIG. 3. At this point, the system stores order data in cloud storage.

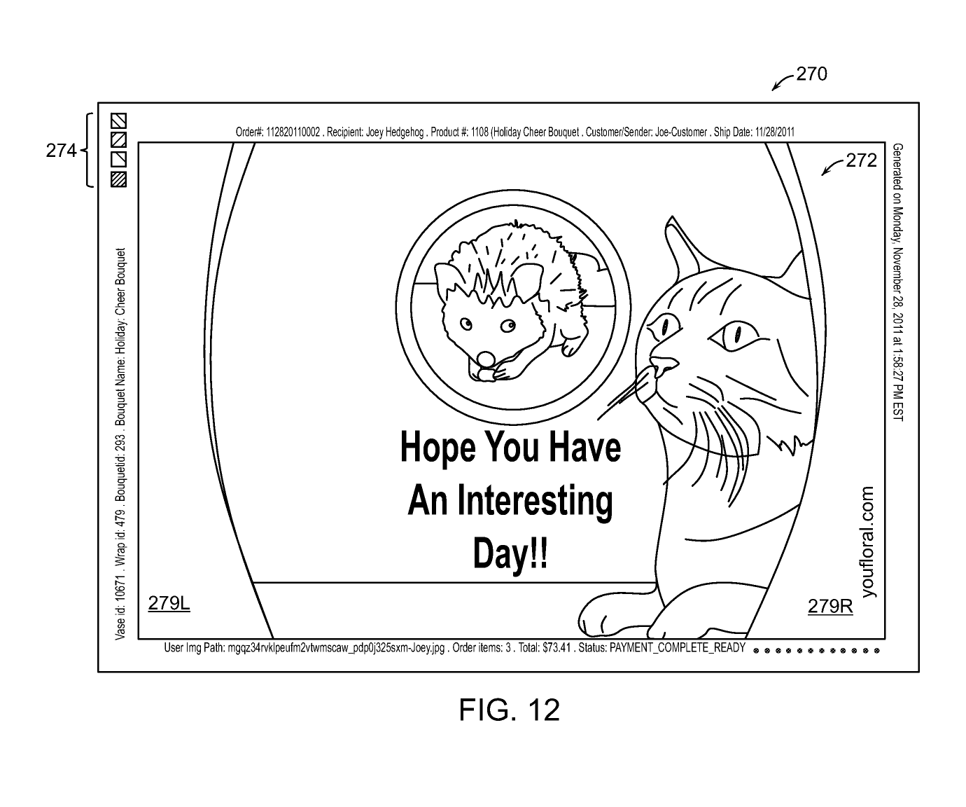

FIG. 12 is an exemplary production decorative image as stored in cloud storage 40. The image 270 is a high-resolution vector image that will be printed by a fulfillment center. In a particular embodiment, the production image is stored in a public display format (PDF) file. Note the order and other information (such as file name, date, template identifier) printed around the peripheral areas of the image. In particular, the production image includes color-check blocks 274. Additionally, bar codes can be printed in the peripheral area. In production, the peripheral area of the image is removed and the central decorative image 272 is displayed with the container. Also note the end “wings” 279L and 279R, which overlap when the image is rolled for assembly to provide a clean transition for the 360° image.

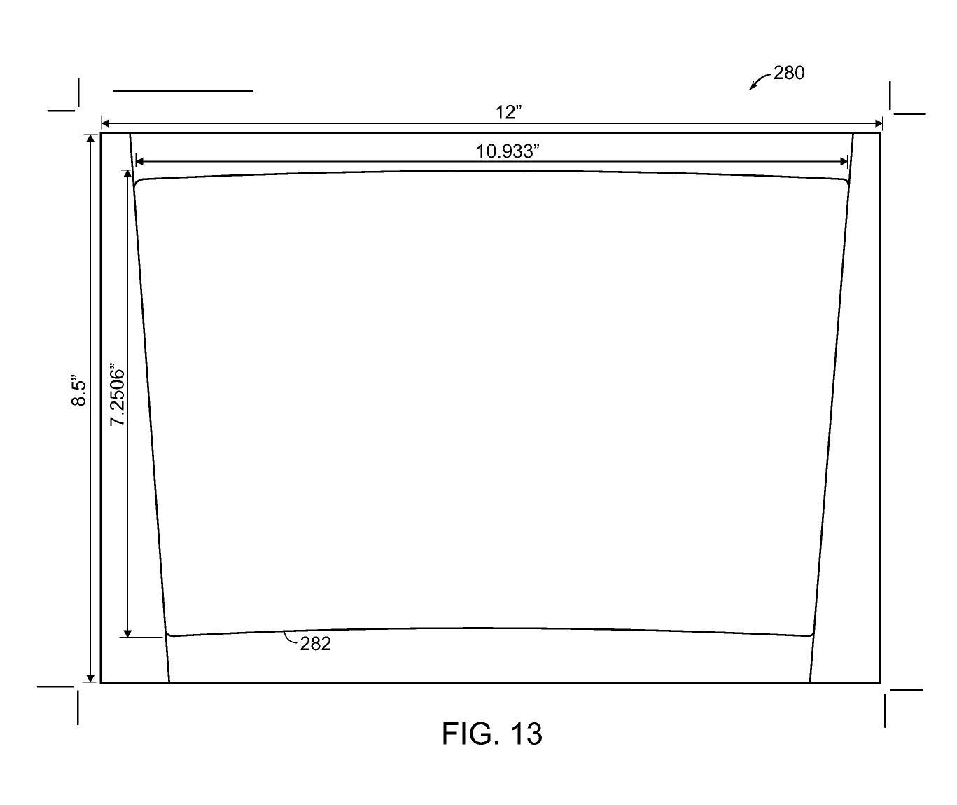

FIG. 13 is an engineering drawing for perforating a sheet of printable medium for use in separating a region having the desired decorative image from the waste peripheral area. Shown are the positions and dimensions for forming micro-perforations 282 in the medium 280. Those positions and dimensions are specific to a particular container, specifically a cylindrical vase. It should be understood that the printable medium can be perforated differently for other cross-sectional vase shapes, such as conical, oval, or multi-walled. In addition, a medium intended for use in a multi-walled vase (e.g. rectangular, square, star, triangular, pentagonal, hexagonal, etc. cross sections) can be pre-scored for folds to accommodate corners in the vase. In general, the delineated image region is a 2-dimensional, planar, representation of the 3-dimensional surface contour of the target container, whether an interior surface contour or an exterior surface contour.

In a particular embodiment, the sheet of printable medium is pre-perforated or otherwise scored before printing. In other embodiments, the sheet of printable medium is die-cut after printing to separate the image region from the waste area.

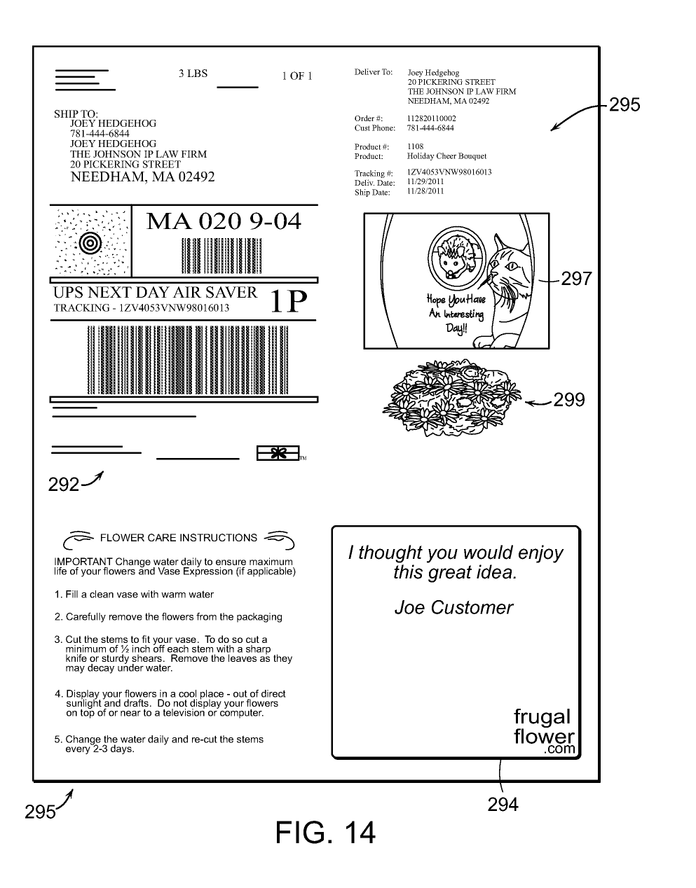

FIG. 14 is an exemplary production order form as stored in cloud storage 40. The order form 290 includes a removable self-adhesive pre-printed shipping label 292, a removable personalized message card 294 from the customer, and details of the order 295 including thumbnail images of the personalized decoration 297 and the selected arrangement 299.

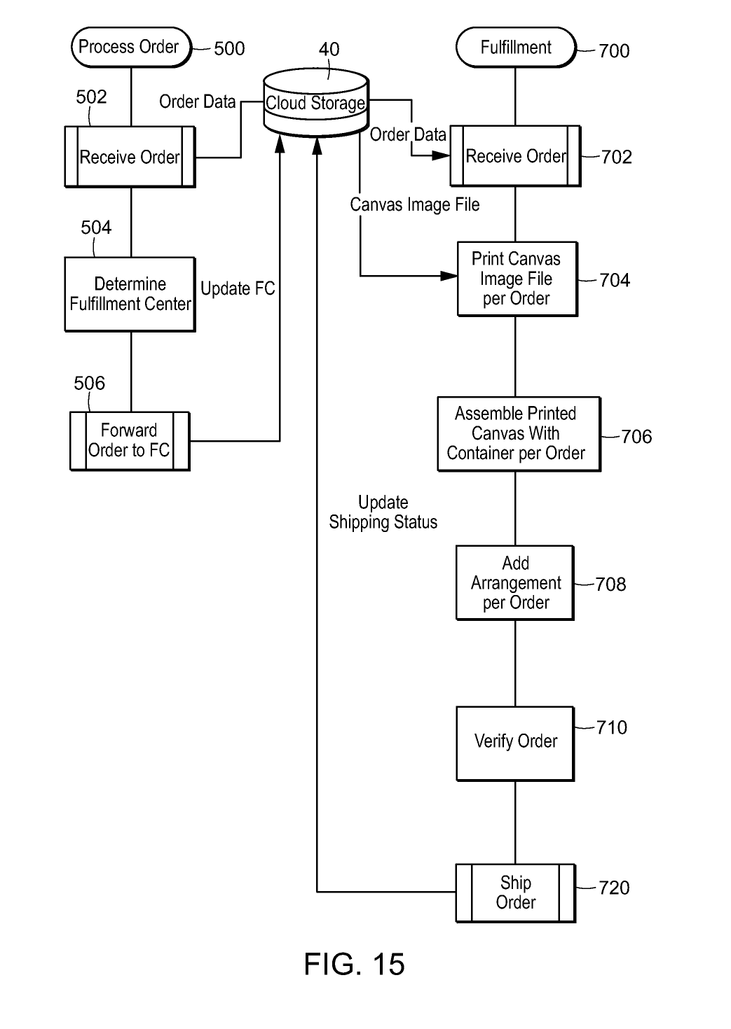

FIG. 15 is a flowchart for back-end processing. As shown, the back-end processing includes processing orders and fulfilling orders.

The steps for processing an order begin at step 500. At step 502, the system receives the order, including order data from cloud storage 40. At step 504, the system determines a fulfillment center based on the delivery address from the order data. At step 506, the identification of the fulfillment center is updated in the order data on cloud storage 40 and the order is forwarded to the fulfillment center.

The steps for fulfilling the order at the fulfillment center begin at step 700. At step 702, the fulfillment center receives the order and retrieves the order data from cloud storage 40.

At step 704, the fulfillment center prints the production image and shipping form as specified in the order. To verify the color accuracy of the printer, the color check blocks 274 are checked after printing. Both the production image and the shipping form are printed on specific substrates or paper.

In a particular embodiment, the personalized decoration is intended to be inserted within a clear vase holding water, which can be acidic. To be successful, the medium used to reproduce the decoration should be resistant to submersion in acidic water for at least as long as the life of the flowers or plants being displayed. In a particular embodiment, the medium maintains the decoration for reuse in subsequent vases or for framing.

To achieve the desired water-resistant performance, a particular embodiment of the invention employs a sheet of waterproof material, which is typically engineered from a substrate of synthetic materials, which can be a multi-layered laminate structure. In a particular embodiment, the sheet of synthetic material is sufficiently rigid to be self-supporting when stood on its edge, especially when immersed in water.

More particularly, 5 mil Solutions II polyester laser film (commercially available from Global Sourcing Solutions, Inc. of Aliso Viejo, Calif.) has been successfully employed with color laser printing to yield a high-quality reusable waterproof image. While the manufacture recommends certain printers and toner, other printers have been used successfully, including HP 6015, HP 3292, and HP 2025 printers. Resulting printed images have been immersed in acidic water for over 6 months without ill effects.

At step 706, the peripheral waste areas of the printed image are removed and the image region of the sheet material is assembled with the container. In particular, the image is inserted inside a clear or translucent vase. The interior-facing mating edges are fastened by a removable waterproof fastener, specifically a vinyl sticker. Alternatively, the printed decoration can be left intact and delivered to the recipient with instruction for assembly.

At step 708, the ordered arrangement is added to the package for delivery. Next, the order is verified at step 710, and then order is shipped for delivery at step 720.

When the printed image is used as an insert in a vase, water will be added. The result is that a thin layer of water forms between the printed decoration and the inside surface of the vase. That thin layer of water slightly magnifies the viewed image and adds depth perception. After its initial use, the printed decoration can be reused with the vase or even mounted for display. The printed decoration can also be used as a wrap around the outside of a vase, basket, or pot. A waterproof film can also be used for an outer wrap so as to maximize the display options to include outdoor display. The decoration can also be printed on the outer surface of a ceramic pot or vase.

As noted above, particular embodiments of the system permit the customer to select individual items for the desired arrangement, such as flowers for a bouquet. The color matching algorithm is used to assist in picking the individual items to help maintain a color scheme. The selection or building of the arrangement need not be done last is the selection process, however. In accordance with another particular embodiment, the customer starts by building an arrangement and the system assists in designing a personalize decoration.

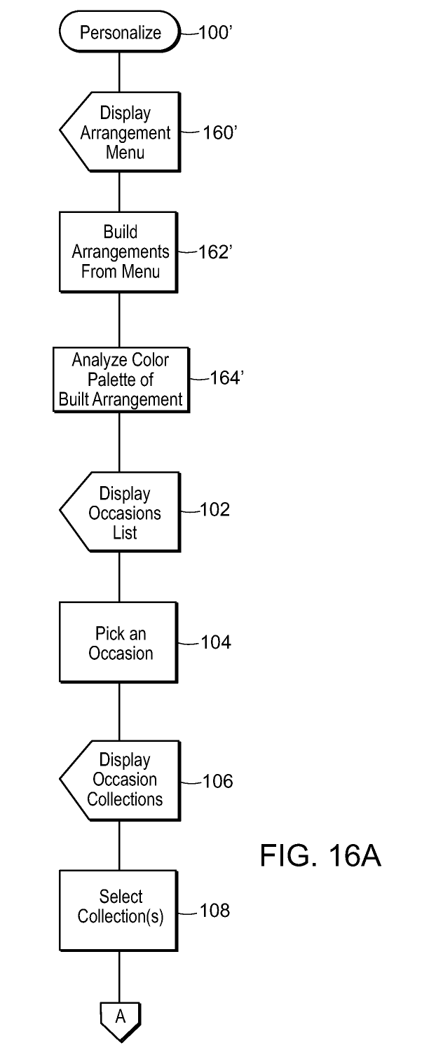

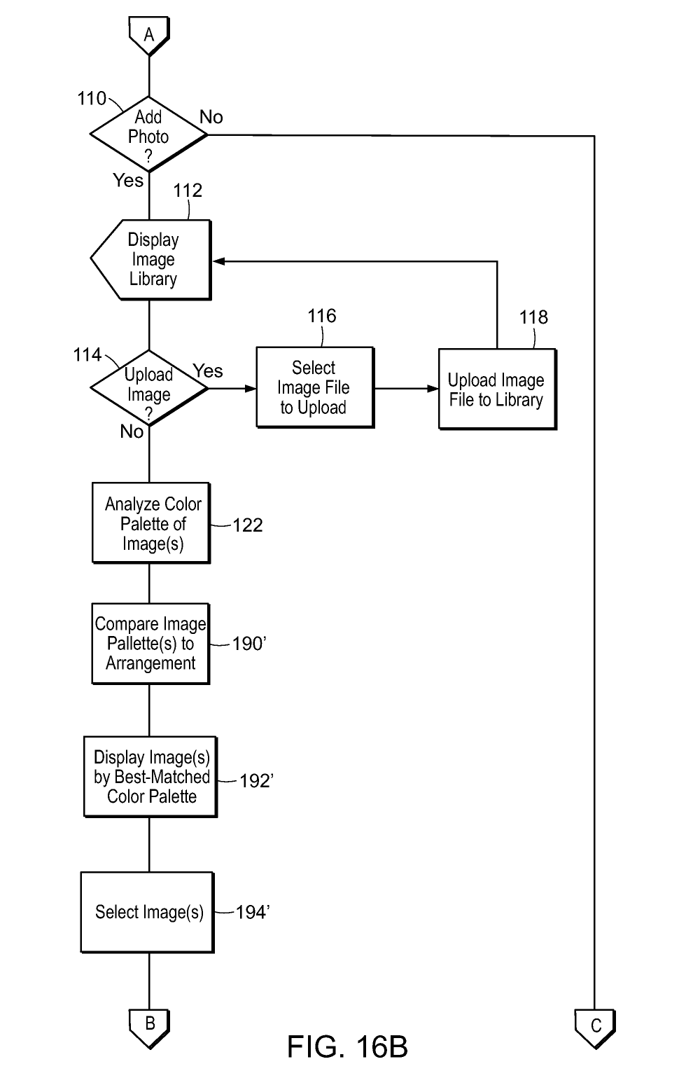

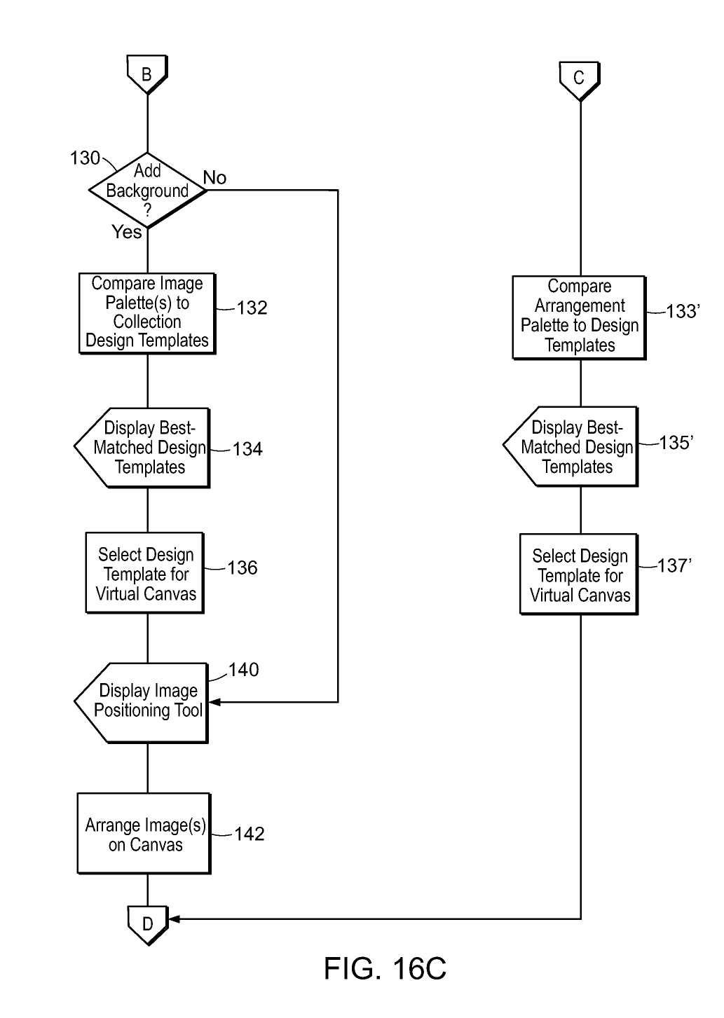

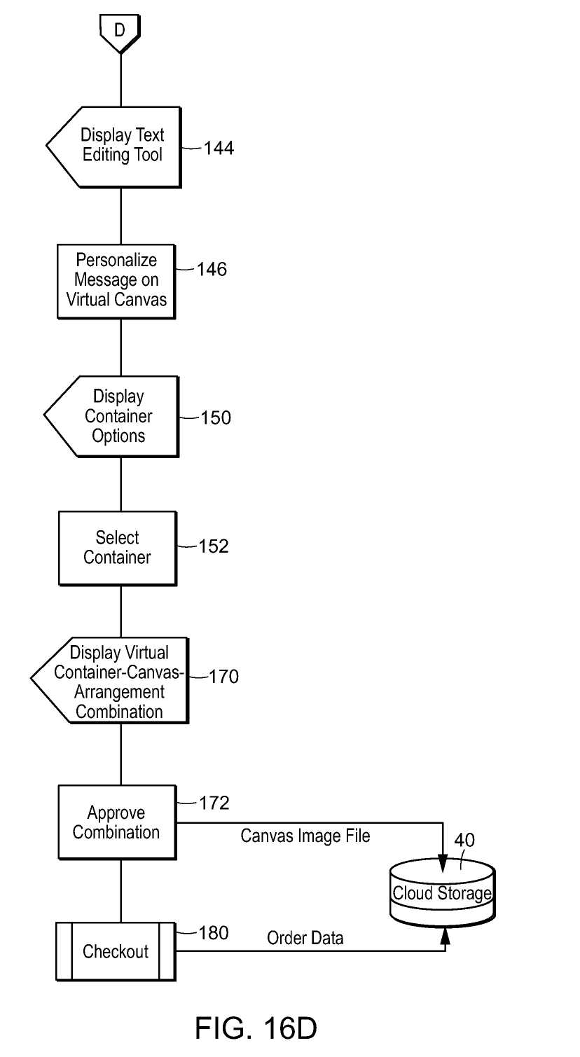

FIG. 16 (consisting of FIGS. 16A-16D) is a flowchart of an alternative embodiment for the personalizing process of FIG. 3. In this embodiment 100′, the customer is assumed to know what arrangement is desired and to want to start based on that knowledge.

At steps 160′-164′, the customer selects an arrangement, which is color analyzed as discussed above with reference to steps 160-164 of FIG. 3. Processing then continues from step 102 as in FIG. 3, with slight modifications.

One modification to the steps of FIG. 3 begins after the customer selects image(s) for the decoration. After the image palettes are analyzed at step 122, the images are color-matched to the arrangement at steps 190′-194′, where the customer selects desired image(s) to use in the decoration.

After those two modified steps, processing again continues similar to the processing in FIG. 3, except that the container is the last customer selection; at step 152 (the arrangement having already been selected).

A similar modification occurs after the customer elects to use a design template without an image. At steps 133′-137′, the design templates for the selected occasion are color-matched to the selected arrangement and the customer selects a desired design template to use in the decoration.

Those of ordinary skill in the art should recognize various alternative processes based on the teachings of FIG. 3 and FIG. 16. As one example, one of ordinary skill in the art can implement embodiments of the invention in helper applications (e.g. mobile apps), instead of website browsing. As another example, various processing steps can combined into a single display screen or selection, such a template-based process.

In yet another embodiment, the system can permit the user to create both the arrangement and the container decoration before employing the color-matching algorithm. In such an embodiment, the user can then activate the color-matching algorithm to calculate a weighted score between the arrangement and container decoration, as described above. The system could then graphically present the weighted score to the user to indicate how well the container decoration complements the arrangement. The user can then accept the created combination or modify either the arrangement or the container decoration, with or without suggestions using the color-matching algorithm.

Those of ordinary skill in the art should recognize that methods involved in the automated system for personalizing containers with artistic arrangements may be embodied as hardware, software, firmware, or in a computer program product that includes a computer-usable medium. For example, such a computer-usable medium can include a readable memory device, such as a solid state memory device, a hard drive device, a CD-ROM, a DVD-ROM, or a computer diskette, having computer-readable program code segments stored thereon. The computer-useable medium can also include a communications or transmission medium, such as a bus or a communications link, whether optical, wired, or wireless, having program code segments carried thereon as digital or analog data signals.

While this invention has been particularly shown and described with references to particular embodiments, it will be understood by those skilled in the art that various changes in form and details may be made to the embodiments without departing from the scope of the invention encompassed by the appended claims. For example, various features of the embodiments described and shown can be omitted or combined with each other.

In particular, the color matching algorithm can be omitted during some steps in the personalization process. For example, because a design template may provide most of the colors for the decorative image, the steps associated with matching images to design templates may be skipped.

1. A computerized method of customizing an artistic arrangement, comprising:
designing a customized container decoration having a personal content item; and
selecting an artistic arrangement from images representing a plurality of artistic arrangements.

2. The method of claim 1, further comprising soliciting the personal content item from a user as a digital image.

3. The method of claim 1, wherein designing the customized container comprises editing a two-dimensional representation of a three-dimensional container surface.

4. The method of claim 3, wherein editing includes digitally adding the personal content item to a digital template.

5. The method of claim 4, further comprising arranging the personal content relative to the digital template.

6. The method of claim 1, wherein designing a customized container decoration includes designing a vase insert.

7. The method of claim 1, wherein selecting the artistic arrangement comprises:
calculating a numerical color palette of the customized container decoration; and
programmatically comparing the numerical color palette of the customized container decoration with a numerical color palette of at least one artistic arrangement.

8. The method of claim 7, further comprising, from the comparison, generating an ordered list of artistic arrangements having numerical color palettes that best match the numerical color palette of the customized container decoration.

9. The method of claim 7, wherein the numerical color palette of the customized container includes the personal content item.

10. The method of claim 1 further comprising combining the customized container decoration with a physical version of the artistic arrangement at a fulfillment center.

11. (canceled)

12. (canceled)

13. (canceled)

14. (canceled)

15. (canceled)

16. The method of claim 30, wherein designing a customized container decoration includes designing a vase insert.

17. (canceled)

18. (canceled)

19. (canceled)

20. (canceled)

21. A computerized system for customizing an artistic arrangement, comprising:
a design interface module for designing a customized container decoration with a personal content item; and
a selection interface module for selecting an artistic arrangement from images representing a plurality of artistic arrangements.

22. (canceled)

23. (canceled)

24. (canceled)

25. A product for customizing a floral vase, comprising:
a sheet of water-resistant material having a printable surface, the sheet having a scored region to define an area that complements an inner surface of a vase; and
an image printed on the printable surface within the scored region.

26. The product of claim 25, wherein the sheet of water-resistant material includes a peripheral area around the scored area.

27. The product of claim 26, wherein the peripheral area includes printed information.

28. The product of claim 27, wherein the information includes color-check information.

29. The product of claim 25, wherein the scored area includes an overlap area.

30. The method of claim 1, wherein the artistic arrangement is a floral arrangement and the container is a vase.
